(19) United States
(12) Patent Application Publication
(10) Pub. No.: US 2007/0057193 A1
(43) Pub. Date: Mar. 15, 2007

(54) Radiation image detector

(75) Inventor: Kaku Irisawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/518,952

(22) Filed: Sep. 12, 2006

(30) Foreign Application Priority Data
Sep. 12, 2005 (JP) 263611/2005

(51) Int. Cl. G01T 1/24

(52) U.S. Cl. 250/370.14

(57) ABSTRACT

A radiation image detector having a layer structure that includes a charge generating layer for generating charges by receiving a recording electromagnetic wave representing a radiation image, and a semiconductor charge trapping layer for trapping the charges generated in the charge generating layer. The charge trapping layer is patterned in correspondence with desired charge trapping regions.

### BACKGROUND OF THE INVENTION

1. Field of the Invention

The present invention relates to a radiation image detector that receives radiation representing a radiation image to record the radiation image therein, and outputs radiation image signals according to the radiation image recorded therein.

2. Description of the Related Art

Various types of radiation image detectors are proposed and put into practical use in the medical and other industrial fields. These detectors generate electric charges by receiving radiation transmitted through a subject and record a radiation image of the subject by storing the electric charges.

One such radiation image detector is proposed, for example, in U.S. Pat. No. 6,770,901. The detector is constituted by a layer structure that includes the following in the order listed below: a first electrode layer that transmits radiation; a recording photoconductive layer that generates electric charges by receiving radiation; a charge trapping layer that acts as an insulator against charges of either polarity and as a conductor for charges of the other polarity; a readout photoconductive layer that generates electric charges by receiving readout light; and a second electrode layer that includes linearly extending transparent line electrodes that transmit the readout light, and linearly extending opaque line electrodes that block the readout light disposed alternately in parallel with each other.

As shown in FIG. 7A, when recording a radiation image using the radiation image detector 50 formed in the manner as described above, radiation transmitted through a subject is irradiated on the detector from the side of the first electrode layer 51 with a negative high voltage being applied to the first electrode layer 51. The radiation irradiated on the detector in the manner as described above is transmitted through the first electrode layer 51 and irradiated on the recording photoconductive layer 52. Then, electric charges are generated in the area of the recording photoconductive layer 52 where the radiation is irradiated, and positive charges of the electric charges move to the negatively charged first electrode layer 51, where they combine with the negative charges charged thereon and disappear. In the mean time, the negative charges of the electric charges generated in the manner as described above move toward the positively charged second electrode layer 55, but they are blocked by the charge trapping layer 53 since it acts as an insulator against negative charges, and accumulated at the interface between the recording photoconductive layer 52 and the charge trapping layer 53, which is referred to as the storage section 56. The accumulation of the negative charges in the storage section 56 constitutes the recording of the radiation image (FIG. 7B).

As shown in FIG. 8, when reading out the radiation image recorded in the radiation image detector 50 in the manner as described above, readout light L1 is irradiated on the detector 50 from the side of the second electrode layer 55. The readout light L1 irradiated on the detector 50 is transmitted through the transparent line electrodes 55a of the second electrode layer 55 and irradiated on the readout photoconductive layer 54, whereby electric charges are generated in the readout photoconductive layer 54. The positive charges generated in the readout photoconductive layer 54 by the irradiation of the readout light L1 combine with the negative charges stored in the storage section 56, while the negative charges of the electric charges combine with the positive charges charged on each of the opaque line electrodes 55b through a charge amplifier 35 connected to each of the opaque line electrodes 55b.

The coupling of the negative charges generated in the readout photoconductive layer 54 with the positive charges charged on the opaque line electrodes 55b causes electric currents to flow through the charge amplifiers 35 according to the radiation image, which are integrated and read out as the radiation image signals proportional to the radiation image.

All the charges stored in the storage section 56 are not read out completely, however, and some of them remain as residual charges after the radiation image is read out by the irradiation of the readout light in the manner as described above. The residual charges remained in the storage section 56 act as noise in the recording and reading of the next radiation image.

In the mean time, the radiation image signals are detected through the coupling of the negative charges generated in the readout photoconductive layer 54 with the positive charges charged on each of the opaque line electrodes 55b through each of the charge amplifiers 35. Accordingly, the major contributor to the readout radiation image signals is the charges stored in the region of the storage section corresponding to each of the opaque line electrodes 55b, and the charges stored in the region of the storage section corresponding to each of the transparent line electrodes 55a do not contribute much to the readout radiation image signals.

That is, storage of the charges that do not contribute much to the readout radiation image signals only to unnecessarily increases the residual charges.

Further, when recording a radiation image in the manner as described above, an electric field is formed between the first electrode layer 51 and the second electrode layer 52 by applying a voltage therebetween as described above. Here, the electric field is concentrated on the outer edge section of the first electrode layer 51, where more charges are injected, and more charges are generated than in the inner region when the radiation is irradiated. Storage of such charges in the storage section 56 disturbs the in-plane distribution of the electric field formed in the readout photoconductive layer 54 when the radiation image signals are read out, thereby the in-plane distribution of the readout radiation image signals is also disturbed.

In the mean time, the radiation image detector described above is generally formed larger than the region of interest for diagnosis. Thus, the charges charged on the outer edge section in the manner as described above are unnecessary charges for obtaining an appropriate diagnostic image, i.e., the charges unnecessary to be stored in the storage section 56.

The present invention has been developed in view of the circumstances described above, and it is an object of the present invention to provide a radiation image detector capable of preventing unnecessary charges, such as those unnecessarily increasing residual charges, or giving unfavorable effects on the readout radiation image signals, from being stored in the detector.

### SUMMARY OF THE INVENTION

A radiation image detector of the present invention comprises a layer structure that includes:

a charge generating layer for generating charges by receiving a recording electromagnetic wave representing a radiation image;

a charge trapping layer for trapping the charges generated in the charge generating layer,

wherein the charge trapping layer is patterned in correspondence with desired charge trapping regions.

In the radiation image detector described above, a configuration may be adopted in which the charge generating layer includes an electrode layer for forming an electric field therein when the recording electromagnetic wave is irradiated, and the charge trapping layer is patterned in the region of the electrode layer inner than the outer edge section thereof.

Further, a configuration may be adopted in which the radiation image detector comprises a layer structure that includes the following in the order listed below: the charge generating layer, the charge trapping layer, a readout photoconductive layer for generating charges by receiving a readout electromagnetic wave; multitude of transparent line electrodes that transmit the readout electromagnetic wave; and multitudes of opaque line electrodes that block the readout electromagnetic wave, each being disposed between the transparent line electrodes, and the charge trapping layer is patterned in correspondence with the opaque line electrodes.

Still further, a configuration may be adopted in which the radiation image detector further includes a detecting section for detecting radiation image signals corresponding to the charges trapped by the charge trapping layer on a pixel by pixel basis, and the charge trapping layer is patterned in which the layer is divided in correspondence with the pixels.

Further, a configuration may be adopted in which the charge trapping layer acts as an insulator against charges of either polarity, and as a conductor for charges of the other polarity.

The referent of “patterned in correspondence with desired charge trapping regions” as used herein means that the charge trapping layer is partially formed in correspondence with desired charge trapping regions instead of being formed on the entire surface of the radiation image detector.

The referent of “desired charge trapping regions” as used herein means the regions where the charges generated in the charge generating layer are desired to be trapped.

The charge trapping layer maybe a layer that stores the charges therein or at the interface thereof.

According to the radiation image detector of the present invention, the charge trapping layer is patterned in correspondence with desired charge trapping regions. If the charge trapping layer is patterned, for example, in correspondence with the opaque line electrodes, the residual charges remaining in the detector may be reduced without decreasing the readout efficiency.

Further, if the charge trapping layer is patterned such that the layer is not formed in the region corresponding to the outer edge section, the disturbance of the in-plane electric field formed in the readout photoconductive layer may be prevented.

### BRIEF DESCRIPTION OF THE DRAWINGS

FIG. 1 is a schematic diagram of the radiation image detector according to an embodiment of the present invention.

FIG. 2A is a cross-sectional view of the radiation image detector shown in FIG. 1 taken along the line 2-2 in FIG. 1.

FIG. 2B is a top view of the radiation image detector shown in FIG. 1.

FIGS. 3A and 3B are drawings for illustrating radiation image recording in the radiation image detector shown in FIG. 1.

FIGS. 4 is a drawing for illustrating radiation image reading from the radiation image detector shown in FIG. 1.

FIG. 5 is a drawing illustrating alternative patterning of the charge trapping layer.

FIG. 6 is a drawing illustrating further alternative patterning of the charge trapping layer.

FIGS. 7A and 7B are drawings for illustrating radiation image recording in the conventional radiation image detector.

FIG. 8 is a drawing for illustrating radiation image reading from the conventional radiation image detector.

### DESCRIPTION OF THE PREFERRED EMBODIMENTS

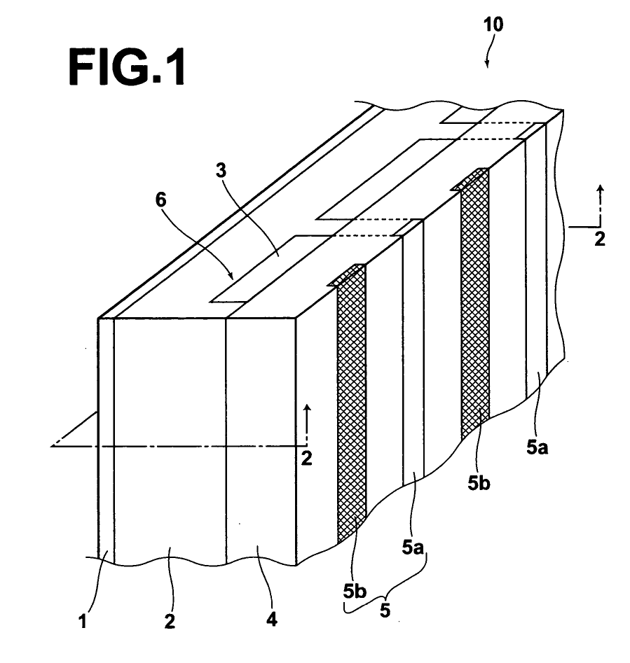

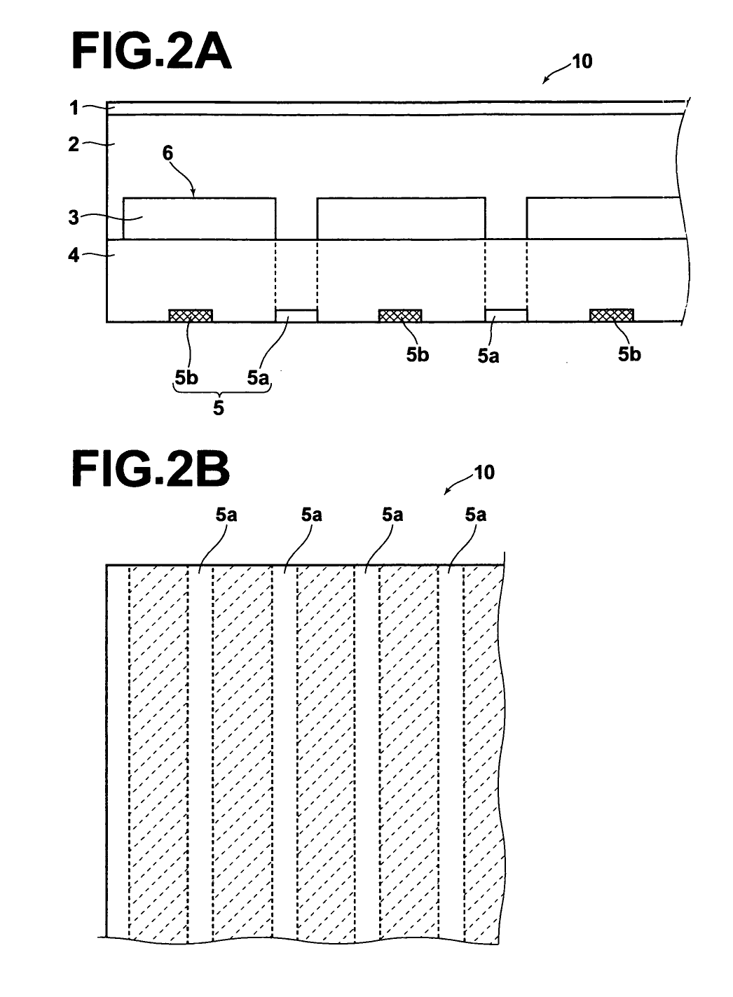

Hereinafter, an embodiment of the radiation image detector of the present invention will be described with reference to accompanying drawings. FIG. 1 is a perspective view of the radiation image detector according to the present embodiment. FIG. 2A is a cross-sectional view of the radiation image detector shown in FIG. 1 taken along the line 2-2 in FIG. 1.

As shown in FIGS. 1 and 2A, the radiation image detector 10 of the present embodiment is constituted by a layer structure that includes the following in the order listed below: a first electrode layer 1 that transmits radiation representing a radiation image; a recording photoconductive layer 2 that generates electric charges by receiving the radiation transmitted through the first electrode layer 1; a charge trapping layer 3 that acts as an insulator against charges of either polarity and as a conductor for charges of the other polarity generated in the recording photoconductive layer 2; a readout photoconductive layer 4 that generates electric charges by receiving readout light; and a second electrode layer 5. In addition, a storage section 6 for storing the electric charges generated in the recording photoconductive layer 2 is formed between the recording photoconductive layer 2 and the charge trapping layer 3. The layers described above are built up on a glass substrate from the second electrode layer 5, but the glass substrate is omitted in FIGS. 1 and 2A. In the present embodiment, the charge trapping layer 3 corresponds to the charge trapping layer described in the claims attached hereto.

The first electrode layer 1 may be made of any material as long as it transmits radiation. For example, a NESA film (SnO₂), ITO (Indium Tin Oxide), IDIXO (Indemitsu Indium X-metal Oxide, Idemitsu Kosan Co., Ltd.), which is an amorphous state transparent oxide film, or the like with a thickness in the range from around 50 to around 200 nm may be used. Alternatively, Al or Au with a thickness of 100 nm may also be used.

The second electrode layer 5 includes a plurality of transparent line electrodes 5a and a plurality of opaque line electrodes 5b. The transparent line electrodes 5a and the opaque line electrodes 5b are disposed alternately in parallel at a predetermined distance.

The transparent electrode 5a is made of an electrically conductive material that transmits the readout light. It may be made of any material as long as it has the properties described above. Such materials include, for example, ITO and IDIXO as in the first electrode layer 1. Alternatively, the electrode 5a may be formed with a metal, such as Al, Cr, or the like, with a thickness that allows the readout light to transmit therethrough (e.g., around 10 nm).

The opaque line electrode 5b is made of an electrically conductive material that blocks the readout light. It may be made of any material as long as it has the properties described above. The opaque line electrode 5b may be made of, for example, Al, Cr or the like, with a thickness which is sufficient to block the readout light.

The recording photoconductive layer 2 may be made of any material as long as it generates electric charges by receiving radiation. Here, a material that includes a-Se as the major component is used, since a-Se has superior properties including high quantum efficiency for radiation and high dark resistance. Preferably, the thickness of the recording photoconductive layer 2 is around 500 μm.

As for the material of the charge trapping layer 3, for example, a material having a greater difference in charge mobility between the charges charged on the first electrode layer 1 and the charges having the opposite polarity when a radiation image is recorded (for example, not less than 10², more preferably, not less than 10³), is preferably used. In this respect, organic compounds such as polyN-vinylcarbazole (PVK), N,N′-diphenyl-N,N′-bis(3-methylphenyl)-[1,1′-biphenyl]-4,4′-diamine (TPD), discotic liquid crystal, and the like, or semiconductor materials, such as TPD-dispersed polymers (polycarbonate, polystyrene, PVK), a-Se doped with 10 to 200 ppm of Cl, AS₂Se₃, As—Se—Te alloys, and the like are preferably used.

Here, as shown in FIG. 1, in the radiation image detector 10 of the present embodiment, the trapping layer 3 is patterned in correspondence with desired charge trap regions. The charge trap regions in the radiation image detector 10 according to the present embodiment are the entire surface of the radiation image detector 10 other than the region corresponding to each of the transparent line electrodes 5a. In other words, the charge trap region is the region corresponding to each opaque line electrode 5b.

FIG. 2B is a top view of the radiation image detector 10 of the present embodiment. The areas indicated by the hatched lines in FIG. 2B are the charge trap regions 7. In FIG. 2B, only those parts of the radiation image detector 10 required for the explanation of the charge trap regions are illustrated for clarity.

The readout photoconductive layer 4 maybe made of any material as long as it shows electrical conductivity by receiving the readout light or erasing light. For example, photoconductive materials that consist mainly of at least one of the materials selected from the group of a-Se, Se—Te, Se—As—Te, nonmetal phthalocyanine, metal phthalocyanine, MgPc (Magnesium phthalocyanie), VoPc (phase II of Vanadyl phthalocyanine), CuPc (Cupper phthalocyanine), and the like are preferably used. Preferably, the thickness of the readout photoconductive layer 4 is 3 μm to 30 μm.

Hereinafter, the operation of the radiation image detector of present embodiment will be described.

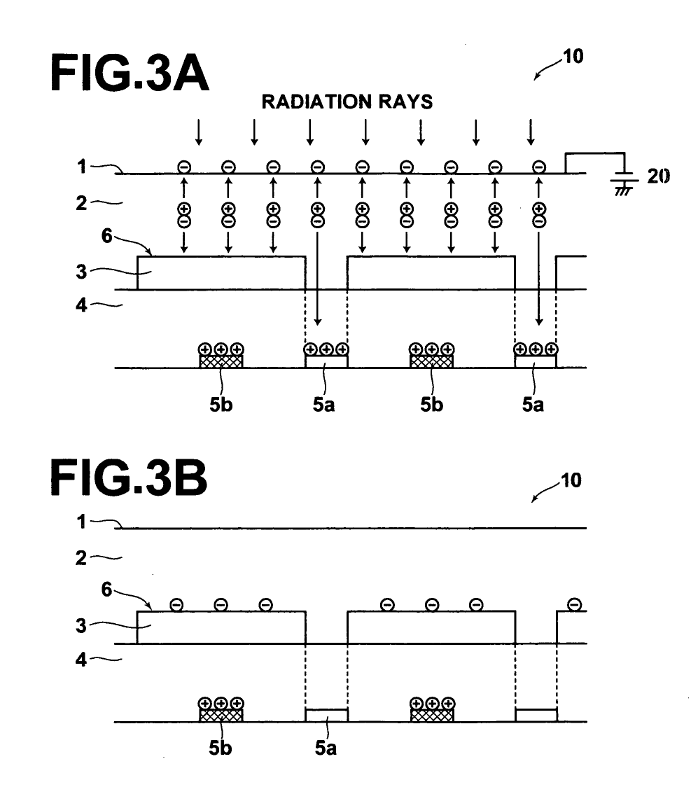

First, as shown in FIG. 3A, radiation is irradiated from a radiation source toward a subject with a negative high voltage being applied from a high voltage source 20 to the first electrode layer 1 of the radiation image detector 10, and the radiation transmitted through the subject and representing a radiation image of the subject is irradiated on the radiation image detector 10 from the side of the first electrode layer 1.

Then, the radiation irradiated on the radiation image detector 10 is transmitted through the first electrode layer 1 and irradiated on the recording photoconductive layer 2, which causes electric charge pairs to be generated in the recording photoconductive layer 2. The positive charges of the electric charge pairs combine with the negative charges charged on the first electrode layer 1 and disappear, while the negative charges of the electric charge pairs are stored in the storage section 6 formed at the interface between the recording photoconductive layer 2 and charge trapping layer 3 as latent image charges, whereby the radiation image is recorded (FIG. 3B).

Here, as shown in FIG. 3A, the charge trapping layer 3 is provided in the charge trap regions corresponding to the opaque line electrodes 5b, and not in the regions corresponding to the transparent line electrodes 5a. Consequently, charges generated in the region of the recording photoconductive layer 2 corresponding to each of the transparent line electrodes 5a pass through the readout photoconductive layer 4 without being trapped by the charge trapping layer 3, then combine with the charges charged on the transparent line electrode 5a and disappear.

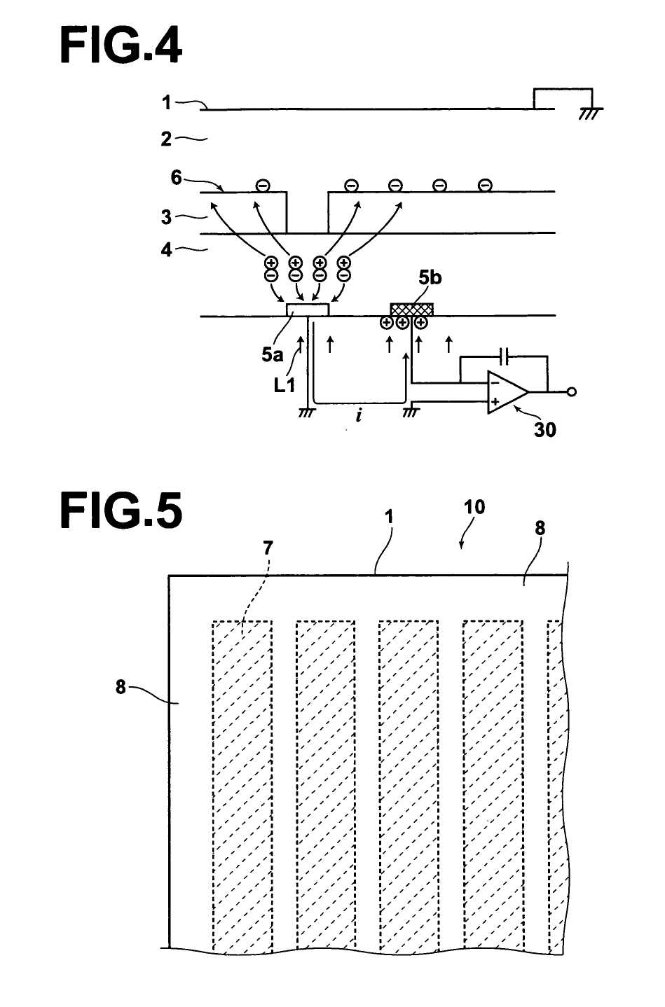

Thereafter, as shown in FIG. 4, with the first electrode layer 1 being grounded, readout light L1 is irradiated on the radiation image detector 10 from the side of the second electrode layer 5, which is transmitted through the first line electrodes 5a and irradiated on the readout photoconductive layer 4. The positive charges generated in the readout photoconductive layer 4 by the irradiation of the readout light L1 combine with the latent image charges stored in the storage section 6, and the negative charges generated in the readout photoconductive layer 4 combine with the positive charges charged on each of the opaque line electrodes 5b through a charge amplifier 30 connected to each of the opaque line electrodes 5b.

The coupling of the negative charges generated in the readout photoconductive layer 4 with the positive charges charged on each of the opaque line electrodes 5b causes electric currents to flow through each of the charge amplifiers 30, which are integrated and detected as the image signals. In this way the image signals are read out from the radiation image detector 10 in proportion to the radiation image.

Here, all the charges stored in the storage section 6 are not read out completely, and some of them remain as residual charges after the radiation image is read out by the irradiation of the readout light in the manner as described above.

In the radiation image detector 10 according to the present embodiment, however, the charge trapping layer 3 is patterned in correspondence with the opaque line electrodes 5b. That is, the charge trapping layer 3 is provided in the region corresponding to each of the opaque line electrodes 5b from which most of the radiation image signals are supplied, and not in the region corresponding to each of the transparent line electrodes 5a from which the radiation image signals are not supplied much. This arrangement may minimize the residual charges remaining in the storage section 6 without decreasing the readout efficiency.

Further, a configuration may be adopted in which erasing light is irradiated on the radiation image detector 10 for erasing the residual charges remaining in the storage section 6 thereof after the radiation image is read out in the manner as described above. The erasing light is irradiated on the radiation image detector 10 from the side of the second electrode layer 5, which causes electric charge pairs to be generated in the readout photoconductive layer 4, and the positive charges of the charge pairs pass through the charge trapping layer 3 and combine with the residual charges remaining in the storage section 6, while the negative charges of the charge pairs combine with the positive charges charged on the opaque line electrodes 5b and disappear.

Here, some of the negative charges also remain in the recording photoconductive layer 2, as well as in the storage section 6 as the residual charges as described above after the radiation image is read out.

Consequently, if the charge trapping layer 3 is not formed in a pattern like, for example, that of the radiation image detector 10 of the present embodiment, the negative charges remaining in the recording photoconductive layer 2 are not erased satisfactorily by the irradiation of the erasing light, since the mobility of the positive charges in the charge trapping layer 3 is not so great.

According to the radiation image detector 10 of the present embodiment, the charge trapping layer 3 is not provided in the region corresponding to each of the transparent line electrodes 5a. This allows the positive charges generated in the readout photoconductive layer 4 by the irradiation of the erasing light to move freely, thereby the negative charges remaining in the recording photoconductive layer 2 may be erased satisfactorily by the positive charges.

Further, when erasing the residual charges described above, a voltage may be applied between the first electrode layer 1 and the transparent line electrodes 5a such that the first electrode layer 1 is charged negatively, and each of the transparent line electrodes 5a is charged positively.

Here, when recording a radiation image in the radiation image detector 10 described above, an electric field is formed between the first electrode layer 1 and the second electrode layer 2 by applying a voltage therebetween as described above. Here, the electric field is concentrated on the outer edge section of the first electrode layer 1, where more charges are injected, and more charges are generated than in the inner region when the radiation is irradiated. Storage of such charges in the storage section 6 disturbs the in-plane distribution of the electric field formed in the readout photoconductive layer 4 when the radiation image signals are read out, thereby the in-plane distribution of the readout radiation image signals is also disturbed.

Consequently, the charge trapping layer 3 may be patterned for example, in the region of the first electrode layer 1 inner than the outer edge section thereof as shown in FIG. 5, in order to prevent the charges from being stored on the outer edge section. In FIG. 5, only those parts required for the explanation are illustrated and other parts are omitted for clarity.

Preferably, the width of the outer edge section is, for example, not less than 3 mm from the outer edge of the first electrode 1. The charge trapping layer may be provided only in the region of interest for diagnosis.

The patterning of the charge trapping layer 3 in the manner as shown in FIG. 5 allows the charges generated in the outer edge section to be absorbed by the second electrode layer 5 without being trapped by the charge trapping layer 3, and the disturbance of the in-plane distribution described above may be prevented.

In the case where only the disturbance of the in-plane distribution needs to be prevented, the charge trapping layer 3 may be provided at the entire area other than the outer edge section. That is, the charge trapping layer may also be provided in the region corresponding to each of the transparent line electrodes 5a.

Here, when reading out the radiation image from the radiation image detector 10 described above, the readout light is scanned by moving the linear light source, which extends in the direction perpendicular to the line electrodes of the second electrode layer 5, in the direction in which the line electrodes are extended.

In accordance with the scanning of the readout light, the radiation image signals are detected sequentially by the charge amplifiers 30 connected to the opaque line electrodes 5b. Then, the image signals detected by the charge amplifiers 30 are sampled at predetermined sampling intervals in correspondence with the scanning, thereby the radiation image signals are detected for each pixel which is the smallest unit forming the radiation image.

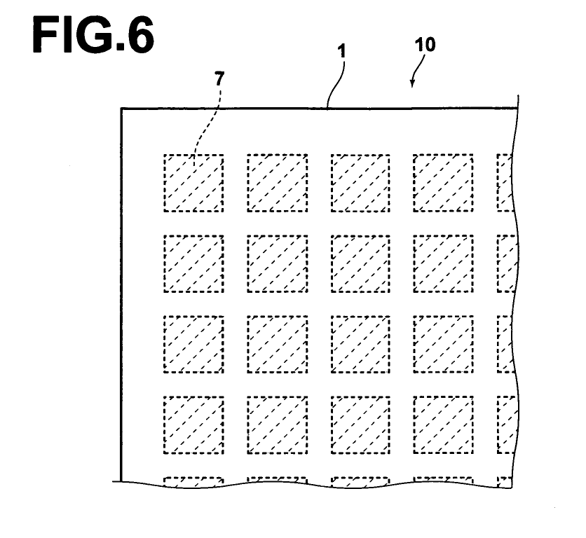

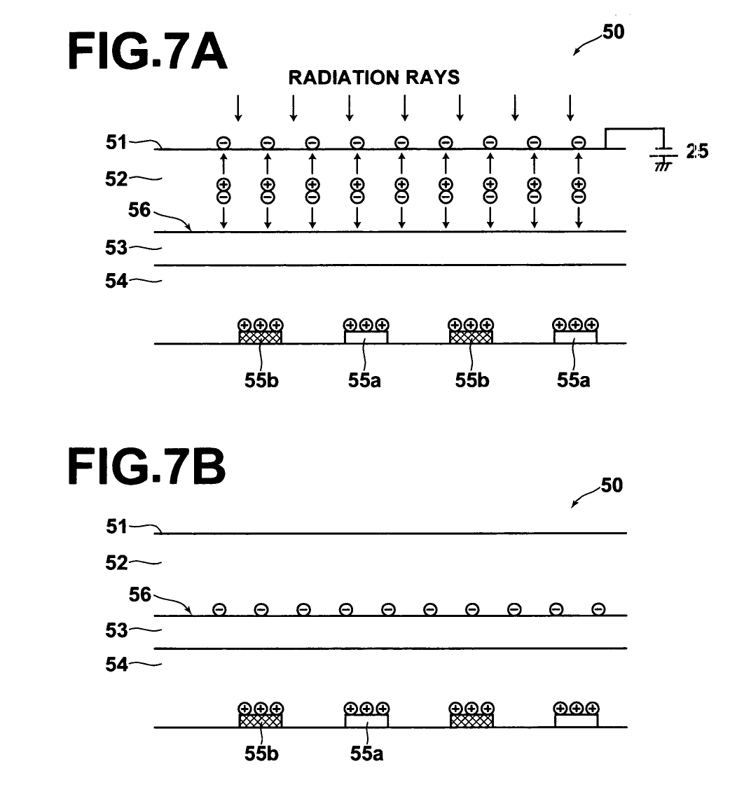

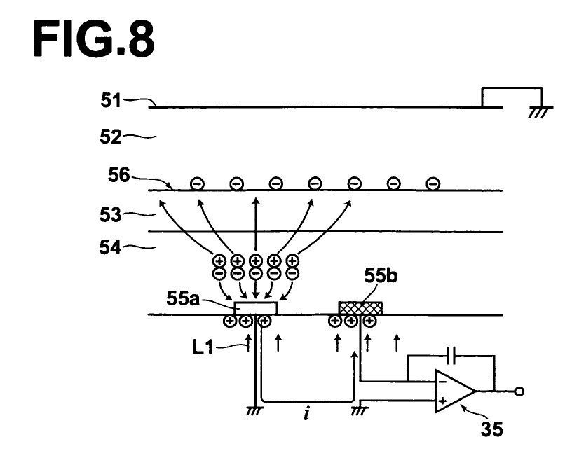

That is, the charge trapping layer 3 may be provided only the regions that contribute to the radiation image signals detected for each pixel. Accordingly, for example, the charge trapping layer 3 may be patterned in which the layer is divided in correspondence with the pixels as shown in FIG. 6, in order to minimize unnecessary charges trapped by the charge trapping layer 3.

In the embodiment described above, the present invention is applied to what is known as the “direct conversion type” radiation image detector, in which a radiation image is recorded in the detector by receiving the radiation and directly converting the radiation to electric charges. The application of the present invention is not limited to this, and it may also be applied, for example, to what is known as the “indirect conversion type” radiation image detector, in which a radiation image is recorded by first converting the radiation to visible light, and then converting the visible light to electric charges.

The layer structure of the radiation image detector of the present invention is not limited to that of the embodiment described above, and a further layer or layers may also be added.

What is claimed is:

1. A radiation image detector comprising a layer structure that includes:
a charge generating layer for generating charges by receiving a recording electromagnetic wave representing a radiation image;
a charge trapping layer for trapping the charges generated in the charge generating layer,
wherein the charge trapping layer is patterned in correspondence with desired charge trapping regions.

2. The radiation image detector according to claim 1, wherein:
the charge generating layer includes an electrode layer for forming an electric field therein when the recording electromagnetic wave is irradiated; and
the charge trapping layer is patterned in the region of the electrode layer inner than the outer edge section thereof.

3. The radiation image detector according to claim 1, wherein:
the detector comprises a layer structure that includes the following in the order listed below:
the charge generating layer,
the charge trapping layer,
a readout photoconductive layer for generating charges by receiving a readout electromagnetic wave;
multitude of transparent line electrodes that transmit the readout electromagnetic wave; and
multitudes of opaque line electrodes that block the readout electromagnetic wave, each being disposed between the transparent electrodes; and
the charge trapping layer is patterned in correspondence with the opaque line electrodes.

4. The radiation image detector according to claim 1, wherein:
the detector further includes a detecting section for detecting radiation image signals corresponding to the charges trapped by the charge trapping layer on a pixel by pixel basis, and
the charge trapping layer is patterned in which the layer is divided in correspondence with the pixels.

5. The radiation image detector according to claim 1, wherein the charge trapping layer acts as an insulator against charges of either polarity, and as a conductor for charges of the other polarity.
